(19) United States
(12) Patent Application Publication
(10) Pub. No.: US 2025/0339773 A1
(43) Pub. Date: Nov. 6, 2025

(54) METHOD FOR CONTROLLING VIRTUAL LENS, APPARATUS FOR CONTROLLING VIRTUAL LENS, STORAGE MEDIUM, AND ELECTRONIC DEVICE

(71) Applicant: NETEASE (HANGZHOU) NETWORK CO., LTD., Hangzhou (CN)

(72) Inventors: Wenjin ZHENG, Hangzhou (CN); Yan LI, Hangzhou (CN)

(21) Appl. No.: 18/871,123

(22) PCT Filed: Mar. 6, 2023
(86) PCT No.: PCT/CN2023/079822

§ 371 Date: Dec. 2, 2024

(30) Foreign Application Priority Data
Jun. 1, 2022 (CN) 202210623013.9

(51) Int. Cl. A63F 13/525

(52) U.S. Cl. CPC A63F 13/525

(57) ABSTRACT

The present disclosure provides a method for controlling a virtual lens. The method includes: determining an object movement velocity and object position information of a virtual object, determining a relative distance between the virtual lens and the virtual object based on the object movement velocity, where the object movement velocity is positively correlated with the length of a mechanical arm of the virtual lens, determining a target position of the virtual lens based on the relative distance and the object position information, and controlling the virtual lens to move to the target position.

The present disclosure is a 371 national phase application of PCT Application No. PCT/CN2023/079822 filed Mar. 6, 2023, which claims priority to Chinese Patent Application No. 202210623013.9 titled “METHOD FOR CONTROLLING VIRTUAL LENS, APPARATUS FOR CONTROLLING VIRTUAL LENS, STORAGE MEDIUM, AND ELECTRONIC DEVICE” and filed on 1 Jun. 2022, the entire contents of both of which applications are hereby incorporated by reference for all purposes.

### TECHNICAL FIELD

The present disclosure relates to the technical field of games, and particularly relates to a method for controlling a virtual lens, an apparatus for controlling a virtual lens, a storage medium, and an electronic device.

### BACKGROUND

Mechanical arm game vision refers to a mode of implementation of a virtual lens used in CG (Computer Graphics) movie shooting and games, which can effectively solve the problem of vision or gaze of a main object such as a virtual character, so that the main object still remains at a corresponding position of the virtual lens when an angle of the virtual lens changes.

In order to maintain and ensure picture composition effects of an overall picture, at present, a relative positional relationship between the virtual lens and the virtual character is adjusted mainly by adjusting the length of a mechanical arm between the virtual lens and the virtual character as shown in FIG. 1 or by allowing the mechanical arm to directly depart from the virtual character or the virtual lens as shown in FIG. 2.

At present, the methods for controlling a virtual lens are relatively monotonous.

### SUMMARY

The present disclosure provides a method for controlling a virtual lens, an apparatus for controlling a virtual lens, a storage medium, and an electronic device, thereby improving the diversity and richness of the method for controlling a virtual lens.

According to a first aspect, the present disclosure provides a method for controlling a virtual lens, the method including: determining an object movement velocity and object position information of a virtual object; determining a relative distance between the virtual lens and the virtual object based on the object movement velocity, where the object movement velocity is positively correlated with the relative distance; determining a target position of the virtual lens based on the relative distance and the object position information; and controlling the virtual lens to move to the target position.

According to a second aspect, the present disclosure provides one or more non-transitory computer-readable storage media containing, in any combination, computer program code that, when executed by a computer system, performs the operations in the above method for controlling a virtual lens.

According to a third aspect, the present disclosure provides a system, including one or more memories collectively containing one or more programs, and one or more processors, where the one or more processors are configured to, individually or collectively, perform the operations in the above method for controlling a virtual lens.

It should be understood that the above general description and the following detailed description are only exemplary and explanatory, and cannot limit the present disclosure.

### DESCRIPTION OF DRAWINGS

The drawings here, which are incorporated in the specification and constitute a part of the specification, illustrate embodiments consistent with the present disclosure, and serve to explain, together with the specification, the principles of the present disclosure. Apparently, the drawings described below are merely some embodiments of the present disclosure. For those of ordinary skills in the art, other drawings may also be obtained based on these drawings without creative work.

FIG. 1 shows a schematic diagram of a graphical user interface provided by a terminal device during runtime in one of example embodiments;

FIG. 2 shows a schematic diagram of a graphical user interface provided by a terminal device during runtime in one of example embodiments;

FIG. 3 shows a schematic diagram of a graphical user interface provided by a terminal device during runtime in one of example embodiments;

FIG. 4 shows a flowchart of a method for controlling a virtual lens in one of example embodiments;

FIG. 5 shows a schematic diagram of a graphical user interface provided by a terminal device during runtime in one of example embodiments;

FIG. 6 shows a flowchart of a method for controlling a virtual lens in one of example embodiments;

FIG. 7 shows a flowchart of a method for controlling a virtual lens in one of example embodiments;

FIG. 8 shows a schematic diagram of a graphical user interface provided by a terminal device during runtime in one of example embodiments;

FIG. 9 shows a flowchart of a method for controlling a virtual lens in one of example embodiments;

FIG. 10 shows a flowchart of a method for controlling a virtual lens in one of example embodiments;

FIG. 11 shows a flowchart of a method for controlling a virtual lens in one of example embodiments;

FIG. 12 shows a schematic diagram of a graphical user interface provided by a terminal device during runtime in one of example embodiments;

FIG. 13 shows a schematic structural diagram of an apparatus for controlling a virtual lens in one of example embodiments; and

FIG. 14 shows a schematic structural diagram of an electronic device in one of example embodiments.

### DETAILED DESCRIPTION

Example embodiments will now be described more comprehensively with reference to the drawings. However, the example embodiments can be implemented in various forms, and should not be construed as being limited to the examples set forth herein; on the contrary, these embodiments are provided to make the present disclosure more comprehensive and complete, and fully convey the concept of the example embodiments to those skilled in the art. The described features, structures, or characteristics may be combined in one or more embodiments in any suitable manner. In the following description, numerous specific details are provided to provide thorough understanding of the embodiments of the present disclosure. However, those skilled in the art will appreciate that the technical solutions of the present disclosure may be practiced with one or more of particular details being omitted, or by adopting other methods, components, apparatuses, steps, etc. In other embodiments, well-known technical solutions are not shown or described in detail to avoid making aspects of the present disclosure become ambiguous because minor issues supersede a major one.

In addition, the drawings are only schematic illustrations of the present disclosure, and are not necessarily drawn to scale. Identical reference numerals in the drawings represent identical or similar parts, thereby omitting repeated description of them. Some of the block diagrams shown in the drawings are functional entities, and do not necessarily correspond to physically or logically independent entities. These functional entities may be implemented in software form, or may be implemented in one or more hardware modules or integrated circuits, or may be implemented in different networks and/or processor apparatuses and/or microcontroller apparatuses.

The flowcharts shown in the figures are illustrative only, and do not necessarily include all steps. For example, some steps may be further decomposed, and some steps may be combined or partially combined, so that the actual execution sequence may vary based on actual situation.

Reference will now be described in detail to examples, which are illustrated in the accompanying drawings. The following description refers to the accompanying drawings in which the same numbers in different drawings represent the same or similar elements unless otherwise represented. The examples described following do not represent all examples consistent with the present disclosure. Instead, they are merely examples of devices and methods consistent with aspects of the disclosure as detailed in the appended claims.

Terms used in the present disclosure are merely for describing specific examples and are not intended to limit the present disclosure. The singular forms “one”, “the”, and “this” used in the present disclosure and the appended claims are also intended to include a multiple form, unless other meanings are clearly represented in the context. It should also be understood that the term “and/or” used in the present disclosure refers to any or all of possible combinations including one or more associated listed items.

Reference throughout this specification to “one embodiment,” “an embodiment,” “an example,” “some embodiments,” “some examples,” or similar language means that a particular feature, structure, or characteristic described is included in at least one embodiment or example. Features, structures, elements, or characteristics described in connection with one or some embodiments are also applicable to other embodiments, unless expressly specified otherwise.

It should be understood that although terms “first”, “second”, “third”, and the like are used in the present disclosure to describe various information, the information is not limited to the terms. These terms are merely used to differentiate information of a same type. For example, without departing from the scope of the present disclosure, first information is also referred to as second information, and similarly the second information is also referred to as the first information. Depending on the context, for example, the term “if”' used herein may be explained as “when” or “while”, or “in response to . . . , it is determined that”.

The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. A module may include one or more circuits with or without stored code or instructions. The module or circuit may include one or more components that are directly or indirectly connected. These components may or may not be physically attached to, or located adjacent to, one another.

A unit or module may be implemented purely by software, purely by hardware, or by a combination of hardware and software. In a pure software implementation, for example, the unit or module may include functionally related code blocks or software components that are directly or indirectly linked together, so as to perform a particular function.

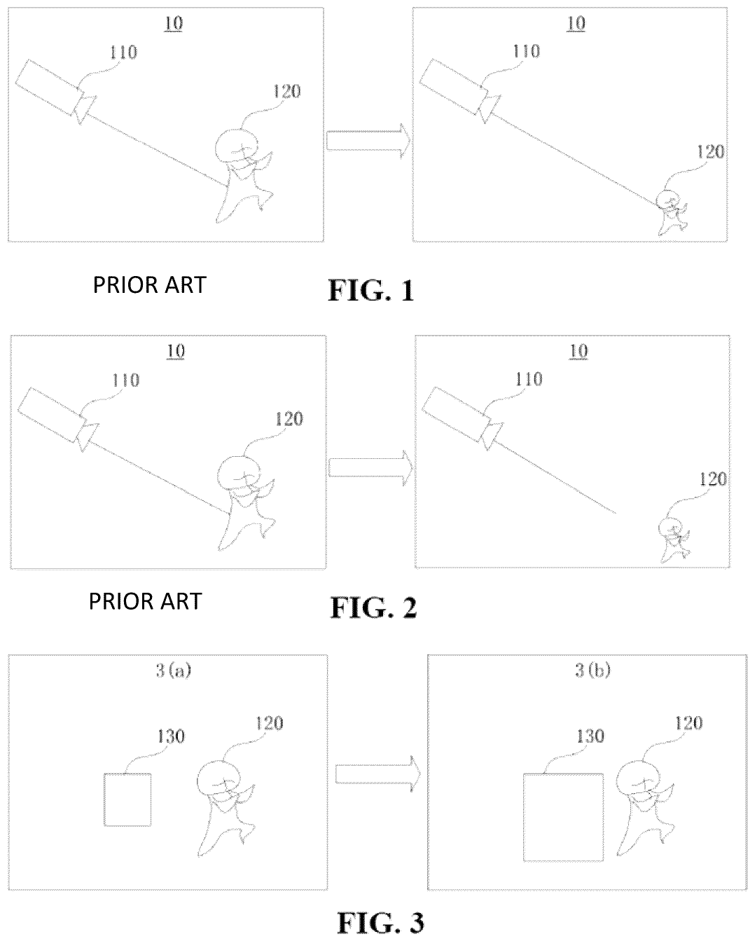

In related technologies, mechanical arm game vision refers to a mode of implementation of a virtual lens used in CG (Computer Graphics) movie shooting and games, which can effectively solve the problem of vision or gaze of a main object such as a virtual character, so that the main object still remains at a corresponding position of the virtual lens when an angle of the virtual lens changes. In order to maintain and ensure picture composition effects of an overall picture, at present, a relative positional relationship between a virtual lens 110 and a virtual object 120 is adjusted mainly by adjusting the length of a mechanical arm between the virtual lens 110 and the virtual object 120 as shown in FIG. 1 or by allowing the mechanical arm to directly depart from the virtual object 120 or the virtual lens 110 as shown in FIG. 2. At present, the methods for controlling a virtual lens are relatively monotonous.

In view of the above problems, an embodiment of the present disclosure provides a method for controlling a virtual lens, to improve the diversity, richness, and smoothness of the method for controlling a virtual lens. An application environment of the method for controlling a virtual lens provided in an embodiment of the present disclosure is briefly introduced as follows:

Embodiments of the present disclosure are applied to a terminal device, which may be a local terminal device, such as a mobile phone, a tablet, a computer, or any other electronic device with a man-machine interaction interface, or may be a client device in a cloud interaction system, such as a server, which is not specifically limited in the embodiments of the present disclosure. Further referring to FIGS. 1 and 2, the terminal device can provide a graphical user interface 10 during runtime. The graphical user interface 10 includes at least one virtual object 120 and a virtual lens 110. The virtual object 120 is a particular object subject, for example, a virtual character of a player in game world, i.e., an object to be controlled by the player. The virtual object 120 may be any virtual image, such as a character, an animal, or a machine, which is not specifically limited in the embodiments of the present disclosure. The virtual object 120 can move based on the player's control in the graphical user interface 10, such as walking, running, jumping, or flying. The virtual lens 110 moves with movement of the virtual object 120, continuously collects images in a field of view of the virtual object 120, and displays the collected images in the graphical user interface 10, for the player to observe contents in a current field of view of the virtual object 120 in the game world in real time. It should be noted that the virtual lens 110 is generally hidden in the graphical user interface 10, or may be displayed in the graphical user interface 10 in real time or under a trigger instruction, which is not specifically limited in the embodiment of the present disclosure, and may be specifically set based on actual situation.

In a movement process of the virtual object 120, in order to ensure the picture composition effects of the overall picture in the graphical user interface 10, the virtual lens 110 will also continuously move with the virtual object 120. Referring to FIG. 3, when the virtual object 120 gradually approaches a reference substance, FIG. 3(a) shows a picture before the virtual object 120 moves, and FIG. 3(b) shows a picture after the virtual object 120 moves. If the length of the mechanical arm between the virtual lens 110 and the virtual object 120 is constant, the proportion of the size of the virtual object 120 in the graphical user interface remains unchanged. However, as the virtual lens 110 gradually approaches a virtual reference substance 130, the proportion of the virtual reference substance 130 in FIG. 3(b) becomes larger, compared to that in FIG. 3(a).

Some nouns in the present disclosure are briefly explained below:

The virtual lens refers to an image collection lens of a virtual camera in the game world, and is configured to collect environmental information within a field of view of a main object or in a virtual scenario.

Virtual mechanical arm: The virtual mechanical arm referred to in the present disclosure is different from an adjustment arm of a camera in real life. The virtual mechanical arm disclosed in the present disclosure refers to a mechanical arm configured to connect the virtual lens and the virtual object in the game world. One end of the virtual mechanical arm is connected to the virtual lens, and the other end is connected to the virtual object or is opposite to the virtual object. If the virtual mechanical arm does not depart from the virtual object, the virtual mechanical arm is a line segment between the virtual lens and the virtual object; while if the virtual mechanical arm departs from the virtual object, the virtual mechanical arm is a line segment with a constant length, with one end connected to the virtual lens, and with the other end free.

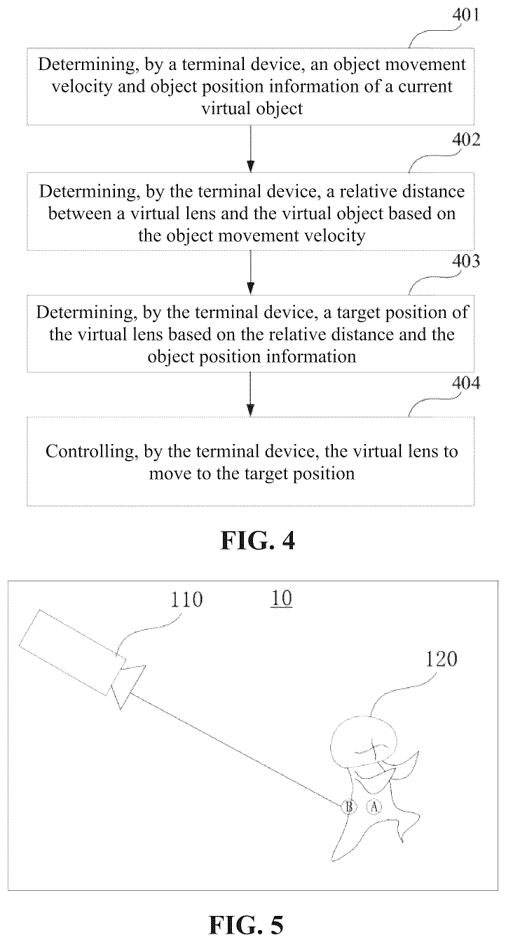

In some embodiments, the above terminal device is an executing body, and the method for controlling a virtual lens is applied to the above terminal device to adjust a position of the virtual lens. Referring to FIG. 4, a method for controlling a virtual lens provided in an embodiment of the present disclosure includes the following steps 401-404:

Step 401: determining, by a terminal device, an object movement velocity and object position information of a current virtual object.

The object movement velocity refers to a velocity of the virtual object with a direction and a magnitude of speed in a movement process, rather than a speed that simply represents the magnitude. The object position information is used to indicate a current position of the virtual object in the game world, and may be represented in any suitable format, such as through the use of coordinates. The object movement velocity may be determined as follows. In a first embodiment, the terminal device calculates the object movement velocity based on a distance between position coordinates of the virtual object in two adjacent frames of pictures and a time interval between the two frames of pictures. In a second embodiment, a server terminal calculates the object movement velocity based on time spent by the virtual object on movement from coordinates of a last position to coordinates of the current position in the game world, and a distance between the coordinates of the last position and the coordinates of the current position, and transmits the object movement velocity to the terminal device. In a third embodiment, the object movement velocity is pre-configured by a game developer based on different game scenarios. For example, a movement velocity in a valley scenario is 1 m/s, a movement velocity in a lawn scenario is 3 m/s, and a movement velocity in an air scenario is 200 m/s, etc. If the virtual object currently moves in the valley scenario, the corresponding object movement velocity is 1 m/s. The ways of determining the object movement velocity include, but are not limited to, the above three ways, and will not be enumerated here.

Step 402: determining, by the terminal device, a relative distance between the virtual lens and the virtual object based on the object movement velocity.

The object movement velocity is positively correlated with the relative distance. The larger the object movement velocity is, the longer the relative distance is. The smaller the object movement velocity is, the shorter the relative distance is. The terminal device can determine the relative distance qualitatively, that is, increase of the object movement velocity correspondingly lengthens the distance between the two, and a smaller velocity correspondingly shortens the distance between the two; or can determine the relative distance quantitatively, for example, a proportional coefficient is set to calculate a product of a value of the object movement velocity and the proportional coefficient, and use the resulting value as the value of the relative distance. The ways of determining the relative distance of the virtual lens based on the object movement velocity include, but are not limited to, the above two ways, will not be enumerated here in this embodiment, and may be selected based on actual situation, as long as a current object movement velocity is positively correlated with the length of the mechanical arm of the virtual lens.

Step 403: determining, by the terminal device, a target position of the virtual lens based on the relative distance and the object position information.

The terminal device constructs a line segment with the length of the relative distance along a direction of an optical axis of the virtual lens with a position corresponding to current object position information of the virtual object as an origin point, wherein a position where an endpoint of the line segment away from the virtual lens is located is the target position of the virtual lens.

Step 404: controlling, by the terminal device, the virtual lens to move to the target position.

After the target position of the virtual lens is obtained based on the above step 403, the virtual lens is moved to the target position, so that a picture composition formed by image information currently collected by the virtual lens matches a current velocity of the virtual object.

The method for controlling a virtual lens provided in the present disclosure first determines an object movement velocity and object position information of a current virtual object, determines a relative distance between the virtual lens and the virtual object based on the object movement velocity, then determines a target position of the virtual lens based on the relative distance and the object position information, and finally adjusts the virtual lens to the target position to complete control of the virtual lens. In a first aspect of the present disclosure, the relative distance between the virtual lens and the virtual object is adjusted in real time based on the object movement velocity of the virtual object. This allows adjusting the relative distance between the virtual lens and the virtual object in real time based on different movement states of the virtual object such as walking, jumping, running, or flying, to construct a picture composition corresponding to a current movement state. The disclosed method greatly enhances sense of velocity of a game picture, thereby solving the technical problem that the methods for controlling a virtual lens being relatively monotonous at present. This approach also achieves the technical effects of improving the diversity and richness of the method for controlling a virtual lens.

In a second aspect, the relative distance between the virtual lens and the virtual object is positively correlated with the virtual lens movement velocity. The farther the virtual mechanical arm is from the virtual object, the larger the movement velocity of the virtual mechanical arm is, and the closer the virtual mechanical arm is to the virtual object, the smaller the movement velocity of the virtual mechanical arm is. This approach makes the virtual lens start and stop movement more smoothly, greatly reducing sense of freezing, and greatly improving smoothness of movement of the virtual lens and picture stability.

Regarding the above adjustment of the mechanical arm to enhance the sense of velocity of the game picture, the following explanation is provided in an embodiment of the present disclosure:

The current object movement velocity of the virtual object is positively correlated with the relative distance between the virtual lens and the virtual object, and the sense of velocity is generated by displacements of other elements around the virtual object. The faster the virtual object moves, the longer the virtual mechanical arm is, the farther the relative distance between the virtual object and the virtual lens is, and the more scenario elements collected by the virtual lens are. Current sense of velocity of the virtual object can be represented by the number or type of scenario element transformations per unit time, and the player can be provided with more information so that the player can determine current scenario state. Correspondingly, the slower the virtual object moves, the shorter the virtual mechanical arm is, the closer the relative distance between the virtual object and the virtual lens is, the closer the scenario elements around the virtual object are to the virtual lens, and the larger the displacement difference displayed on a current interface is, thereby enhancing the sense of velocity of the virtual object.

In view that the above current object movement velocity of the virtual object is positively correlated with the length of the mechanical arm of the virtual lens, the following explanation is provided in an embodiment of the present disclosure:

Referring to FIG. 5, point A is used to represent a position of the above virtual object 120, and point B is used to represent an end point of the mechanical arm of the virtual lens 110 close to the virtual object 120. Assume that an time interval between a current frame of game picture and a last frame of game picture is t, a coordinate of virtual object A is Anew in the current frame, and is Aold in the last frame; a coordinate of end point B of the mechanical arm of the virtual lens is Bnew in the current frame, and is Bold in the last frame; and a mechanical arm mixing coefficient is T,

$$Mechanical arm velocity of the virtual lens Bv = ( Bnew - Bold ) / t \qquad ( 1 )$$

Coordinate of the virtual lens in the current frame

$$Bnew = [ Anew \times clamp ( t / T , 0 , 1 ) ] + \{ Bold \times [ 1 - clamp ( t / T , 0 , 1 ) ] \} \qquad ( 2 )$$

Clamp (A, B, C) represents a responsive layout function, which is used to limit the value of A to not less than B and not greater than C. If the mechanical arm mixing coefficient T=1, and 0<t<1, the above formula (2) can be converted into the following formula (3):

$$Bnew = ( Anew \times t ) + [ Bold \times ( 1 - t ) ] \qquad ( 3 )$$

The above formula (3) is simplified as follows:

$$Bnew = ( Anew \times t ) + [ Bold \times ( 1 - t ) ] \qquad ( 3 )$$

$$Bnew = ( Anew \times t ) + Bold - ( Bold \times t )$$

$$Bnew - Bold = ( Anew \times t ) - ( Bold \times t )$$

$$( Bnew - Bold ) / t = Anew - Bold \qquad ( 4 )$$

Based on the formula (1) and the formula (4), the following may be obtained:

$$Mechanical arm velocity Bv = Anew - Bold \qquad ( 5 )$$

$$Object movement velocity of the virtual object Av = ( Anew - Aold ) t \qquad ( 6 )$$

When the mechanical arm velocity Bv of the virtual lens is consistent with the object movement velocity Av of the virtual object, the distance between the virtual object and the mechanical arm of the virtual lens remains unchanged, that is, the distance between the virtual object and the virtual lens is constant:

$$Av = Bv \qquad ( 7 )$$

The formulas (5) and (6) are substituted into the above formula (7) to obtain the following formula (8):

$$( Anew - Aold ) / t = Anew - Bold \qquad ( 8 )$$

Further, a movement distance of the virtual mechanical arm per unit time is consistent with a movement distance of the virtual object per unit time, that is, Anew−Aold=Bnew−Bold, which is substituted into the formula (8) to obtain the following formula (9):

$$( Bnew - Bold ) / t = Anew - Bold \qquad ( 9 )$$

As can be clearly seen from the formulas (8) and (9), the formula (2) can make a distance between a start point of the virtual mechanical arm and the virtual object infinitely close to a movement velocity value of the virtual object. Although physical units of the two are different, nondimensionalized values of them may be infinitely close. The movement velocity of the virtual lens and the distance between it and the virtual object can be automatically adjusted as the object movement velocity of the virtual object changes. In the adjustment process, when the distance between the virtual mechanical arm and the virtual object is pulled to be consistent with a value (or a ratio) of the object movement velocity of the virtual object, the distance between the virtual lens and the virtual object remains at a constant value.

Regarding the above improvement in the smoothness of movement of the virtual lens, the following explanation is provided in an embodiment of the present disclosure:

Assume that: Aₓ is a coordinate of the virtual object A in an X-th frame, Cₓ is a coordinate of end point C on one side of the virtual mechanical arm of the virtual lens away from the virtual object A in the X-th frame; Aₓ₊₁ is a coordinate of the virtual object A in an (X+1)-th frame, Cₓ₊₁ is a coordinate of the end point C of the virtual mechanical arm in the (X+1)-th frame; Aₓ₊₂ is a coordinate of the virtual object A in an (X+2)-th frame, and Cₓ₊₂ is a coordinate of the end point C of the virtual mechanical arm in the (X+2)-th frame.

When a time interval between two frames is t, and 0<t<1, based on the above formula (3), a coordinate of the end point C of the virtual mechanical arm in a first frame is:

$${C}_{x + 1} = ( {A}_{x + 1} \times t ) + [ {C}_{x} \times ( 1 - t ) ] \qquad ( 10 )$$

A coordinate of the end point C of the virtual mechanical arm in a second frame is:

$${C}_{x + 2} = ( {A}_{x + 2} \times t ) + [ {C}_{x + 1} \times ( 1 - t ) ] \qquad ( 11 )$$

Assuming that object A remains stationary between two frames, i.e., Aₓ₊₁=Aₓ₊₂, which is substituted into the formula (11) to obtain:

$${C}_{x + 2} = ( {A}_{x + 1} \times t ) + [ {C}_{x + 1} \times ( 1 - t ) ] \qquad ( 12 )$$

Formula (10) is subtracted from (12) to obtain:

$${C}_{x + 2} - {C}_{x + 1} = ( {A}_{x + 1} \times t ) + [ {C}_{x + 1} \times ( 1 - t ) ] - ( {A}_{x + 1} \times t ) - [ {C}_{x} \times ( 1 - t ) ] \qquad ( 13 )$$

$${C}_{x + 2} - {C}_{x + 1} = ( 1 - t ) \times ( {C}_{x + 1} - {C}_{x} )$$

As can be seen from the formula (13):
when the virtual mechanical arm continuously approaches the virtual object A, the velocity becomes smaller and smaller and infinitely approaches 0, and a current movement distance of the virtual mechanical arm is (1-t) times that of a movement distance of the last frame. At equal frame interval time, the virtual mechanical arm has an ability to slow down. Otherwise, when the virtual mechanical arm continuously moves away from the virtual object A, the velocity of the virtual mechanical arm becomes larger and larger and infinitely approaches the velocity of the virtual object A. Further, the virtual mechanical arm slowly accelerates, until when the distance between the virtual mechanical arm and the virtual object A is pulled to be consistent with a value (or a ratio) of the velocity of virtual object A, the distance between the virtual lens and the virtual character A remains at a constant value.

Formula (3) allows the motion law of the virtual mechanical arm to be manifested as controlling acceleration based on distance. This law is consistent with a motion law of a spring tied between the start point of the virtual mechanical arm and the virtual object A.

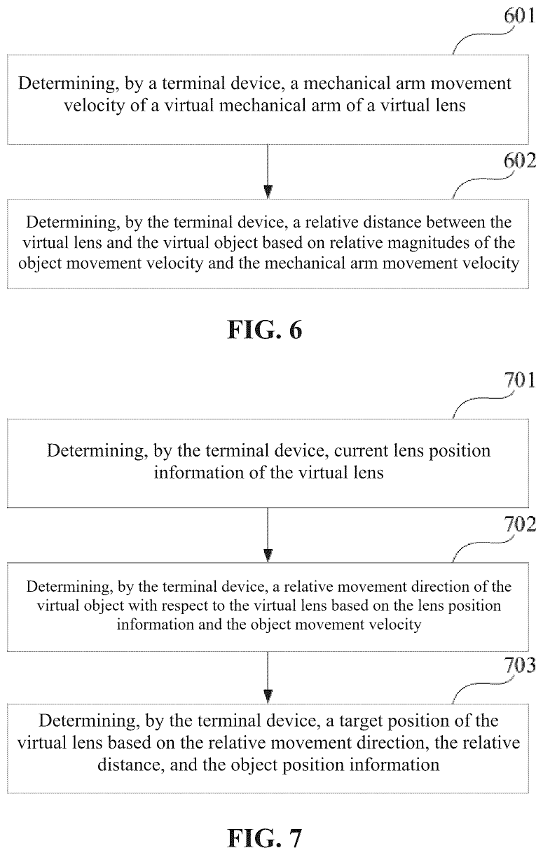

Referring to FIG. 6, in an optional embodiment of the present disclosure, the above step 402: determining the relative distance between the virtual lens and the virtual object based on the object movement velocity includes the following steps 601-602:

Step 601: determining, by a terminal device, a mechanical arm movement velocity of a virtual mechanical arm of a virtual lens.

The mechanical arm movement velocity may be a movement velocity of one end of the mechanical arm close to the virtual object may be a movement velocity of any other position on the virtual mechanical arm, which is not specifically limited in this embodiment.

Step 602: determining, by the terminal device, a relative distance between the virtual lens and the virtual object based on relative magnitudes of the object movement velocity and the mechanical arm movement velocity.

As explained in the above steps, the object movement velocity is positively correlated with the movement velocity of the virtual mechanical arm. The terminal device can determine a magnitude of the object movement velocity based on a preset movement velocity. In this embodiment, the terminal device determines the relative magnitude of the object movement velocity based on the mechanical arm movement velocity, and the resulting relative distance between the virtual lens and the virtual object is more consistent with a state of the virtual object in an actual game scenario, achieving higher reliability.

In the present disclosure, the above step 602: determining, by the terminal device, a relative distance between the virtual lens and the virtual object based on relative magnitudes of the object movement velocity and the mechanical arm movement velocity includes two embodiments as follows:

in a first embodiment, if the object movement velocity is greater than the mechanical arm movement velocity, a distance between the virtual lens and the virtual object is increased to obtain the relative distance.

In a second embodiment, if the object movement velocity is smaller than the mechanical arm movement velocity, a distance between the virtual lens and the virtual object is shortened to obtain the relative distance.

The terminal device can first determine the relative magnitude of the object movement velocity and the mechanical arm movement velocity. If the object movement velocity is greater than the mechanical arm movement velocity, it means that the virtual object currently moves fast, and the distance between the virtual lens and the virtual object is correspondingly increased. Otherwise, if the object movement velocity is smaller than the mechanical arm movement velocity, it means that the virtual object currently moves slowly, and the distance between the virtual lens and the virtual object is correspondingly shortened. The virtual object movement velocity is determined based on the relative magnitude of the mechanical arm movement velocity, so that the resulting relative distance of the virtual lens is more consistent with the state of the virtual object in the actual game scenario, achieving higher reliability.

In an optional embodiment of the present disclosure, a nondimensionalized value of the object movement velocity is equal to a nondimensionalized value of the relative distance.

As shown in the above formula (9):

$$Av = Bv = ( Bnew - Bold ) / t = Anew - Bold \qquad ( 9 )$$

Av is the object movement velocity, and Anew−Bold is the relative distance. Values of the two are adjusted to an equal value, so that the object movement velocity of the virtual object is kept to be equal to the mechanical arm movement velocity of the virtual lens, which means that the relative distance between the virtual object and the virtual lens has reached a maximum value, and more information can be collected on the premise of maintaining a picture composition, thus allowing a player to determine a current environment of the virtual object, and further improving the game experience of the player.

Referring to FIG. 7, in an optional embodiment of the present disclosure, the above step 403: determining, by the terminal device, a target position of the virtual lens based on the relative distance and the object position information includes the following steps 701-703:

Step 701: determining, by the terminal device, current lens position information of the virtual lens.

In an embodiment, the terminal device determines a current position of the virtual lens, and the lens position information can be characterized in any way, such as by coordinates.

Step 702: determining, by the terminal device, a relative movement direction of the virtual object with respect to the virtual lens based on the lens position information and the object movement velocity.

Velocity is directional. In this embodiment, the relative movement direction of the virtual object with respect to the virtual lens is determined based on the velocity directionality and the lens position. The relative movement direction may be leftward movement, rightward movement, forward movement, or backward movement, etc. The terminal device may further determine a specific angle of the relative movement direction of the virtual object with respect to the virtual lens based on a specific velocity standardized vector, which is not specifically limited in this embodiment.

Step 703: determining, by the terminal device, the target position of the virtual lens based on the relative movement direction, the relative distance, and the object position information.

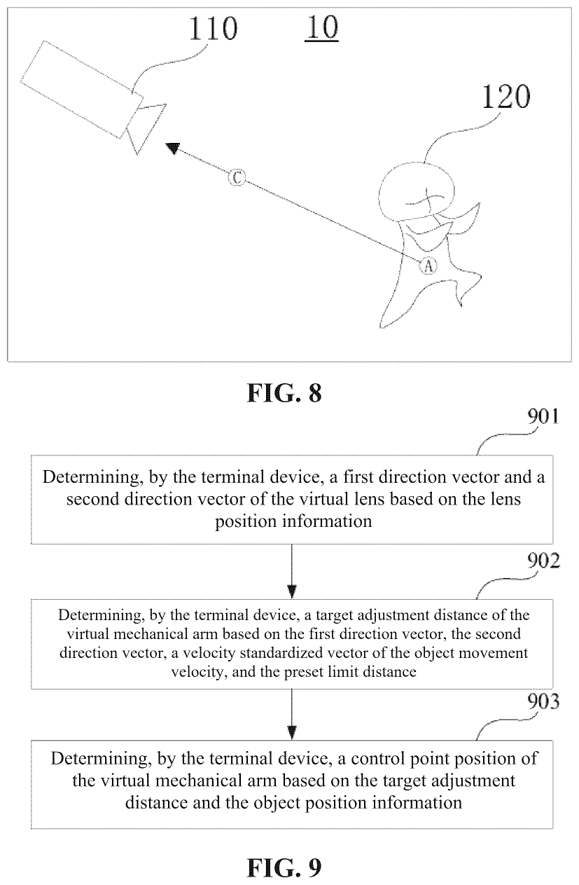

For example, in FIG. 8, the relative movement direction is forward movement, the relative distance is 10 m, the object position information of virtual object 120 is point A (x₀, y₀, z₀), the terminal device emits a ray to the virtual lens 110 with the point A (x₀, y₀, z₀) as the origin point, and a position corresponding to a point on the ray that is 10 m away from the virtual object 120 (point C in FIG. 8) is the target position corresponding to the virtual lens.

In an embodiment of the present disclosure, the relative movement direction of the virtual object with respect to the virtual lens is first determined based on the lens position information and the object movement velocity, and then the target position of the virtual lens is determined based on the relative movement direction, the relative distance, and the object position information, thereby taking into account different lens requirements of the virtual object in different movement directions to the maximum extent, determining the corresponding target position of the virtual lens based on an actual movement direction, and further improving the flexibility, comprehensiveness, and reliability of the method for controlling a virtual lens in the embodiments of the present disclosure.

In the present disclosure, the above step 703: determining, by the terminal device, a target position of the virtual lens based on the relative movement direction, the relative distance, and the object position information includes two embodiments as follows:
in a first embodiment, the terminal device determines a position having the relative distance from a position where the virtual object is located as the target position of the virtual lens, if the relative movement of the virtual object with respect to the virtual lens is in a direction toward the virtual lens.

The relative movement direction of the virtual object with respect to the virtual lens is toward the virtual lens, indicating that the virtual object moves forward with respect to the virtual lens. In this embodiment, the virtual lens can collect most scenario elements of an environment where the virtual object is located. Therefore, the terminal device can directly determine the position having the relative distance from the position where the virtual object is located as the target position of the virtual lens based on the manner disclosed in the above step 703.

In a second embodiment, the terminal device determines control point position information of the virtual mechanical arm based on the object position information, the object movement velocity, the lens position information, and a preset limit distance, if the relative movement direction of the virtual object with respect to the virtual lens is away from the virtual lens.

The mechanical arm control point refers to an end point of the mechanical arm of the virtual lens away from the virtual lens. The relative movement direction of the virtual object with respect to the virtual lens is away from the virtual lens, that is, the virtual object moves leftward, rightward, or backward with respect to the virtual lens. When the virtual object moves leftward, rightward, or backward with respect to the virtual lens, the virtual lens retains behind the virtual object, and collects fewer scenario elements. Therefore, in this embodiment, the terminal device determines the control point position information of the virtual mechanical arm based on the object position information, the object movement velocity, the lens position information, and the preset limit distance, and then determines the target position of the virtual lens based on mechanical arm control point information, thereby ensuring that the virtual lens collects more information to the maximum extent, enhancing the sense of velocity of the virtual object during movement, and further improving the game experience of the player.

Referring to FIG. 9, in the present disclosure, in the above second embodiment, the terminal device determines the control point position information of the virtual mechanical arm based on the object position information, the object movement velocity, the lens position information, and the preset limit distance, including the following steps 901-903:

Step 901: determining, by the terminal device, a first direction vector and a second direction vector of the virtual lens based on the lens position information.

The lens position information refers to a position of the virtual lens, and then a first direction vector and a second direction vector of the virtual lens are determined based on the position. Planes where the first direction vector and the second direction vector are located are parallel to a plane where the virtual lens is located, and the first direction vector is perpendicular to the second direction vector. For example, the plane where the virtual lens is located is plane yz of a spatial coordinate system, the first direction vector may be +x, and the second direction vector may be −y or +y. Or, in other words, the first direction vector includes a forward direction with respect to the lens, and the second direction vector includes a leftward or rightward direction with respect to the lens.

Step 902: determining, by the terminal device, a target adjustment distance of the virtual mechanical arm based on the first direction vector, the second direction vector, a velocity standardized vector of the object movement velocity, and the preset limit distance.

The velocity standardized vector refers to a unit vector of the virtual object movement velocity, the preset limit distance refers to a maximum range or maximum distance that the virtual object can move, and the target adjustment distance refers to a distance between an end point of the virtual mechanical arm and the virtual object. When the relative movement direction of the virtual object with respect to the virtual lens is away from the virtual lens, the terminal device determines the target adjustment distance of the virtual mechanical arm based on the first direction vector and the second direction vector of the virtual lens, the velocity standardized vector of the object movement velocity, and the preset limit distance, so that the mechanical arm of the virtual lens can automatically adjust the distance based on an actual movement state of the virtual object to obtain a target adjustment distance that is most suitable for a current state.

Step 903: determining, by the terminal device, a control point position of the virtual mechanical arm based on the target adjustment distance and the object position information.

For example, the object position information of the virtual object is (x₁, y₁, z₁), the terminal device draws a circle horizontally with (x₁, y₁, z₁) as the center of circle and with the target adjustment distance as the radius, and a position of an intersection point of the circle and the virtual mechanical arm is a mechanical arm control point position.

In an embodiment of the present disclosure, when the relative movement direction of the virtual object with respect to the virtual lens is away from the virtual lens, the terminal device determines the target adjustment distance of the virtual mechanical arm based on the first direction vector and the second direction vector of the virtual lens, the velocity standardized vector of the object movement velocity, and the preset limit distance, and determines the control point position of the virtual mechanical arm based on the target adjustment distance, so that the mechanical arm control point position of the virtual mechanical arm can automatically adjust the distance based on the actual movement state of the virtual object to obtain a target position that is most suitable for the current state, thereby greatly improving the flexibility and reliability of the virtual lens control.

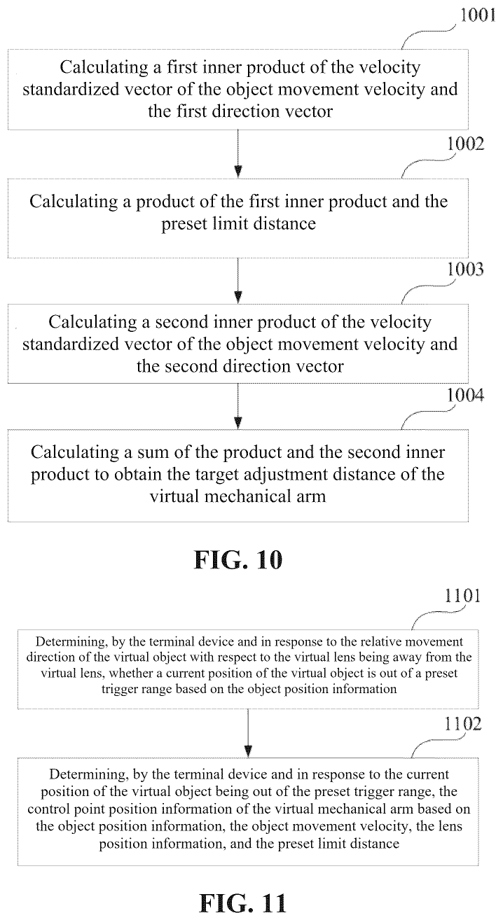

Referring to FIG. 10, in an optional embodiment of the present disclosure, the step 902: determining, by the terminal device, a target adjustment distance of the virtual mechanical arm based on the first direction vector, the second direction vector, a velocity standardized vector of the object movement velocity, and the preset limit distance includes the following steps 1001-1004:

Step 1001: calculating a first inner product of the velocity standardized vector of the object movement velocity and the first direction vector;

Step 1002: calculating a product of the first inner product and the preset limit distance;

Step 1003: calculating a second inner product of the velocity standardized vector of the object movement velocity and the second direction vector; and

Step 1004: calculating a sum of the product and the second inner product to obtain the target adjustment distance of the virtual mechanical arm.

For example, the terminal device can calculate the target adjustment distance based on the following formula (14):

$$D = S \times [ clamp ( {C}_{RV} {dotP}_{V} , - 1 , 1 ) + clamp ( {C}_{FV} {dotP}_{V} , - 1 , 0 ) ] \qquad ( 14 )$$

In the formula (14), D represents the target adjustment distance, S represents the preset limit distance, C_{RV} represents the first direction vector of the virtual lens, C_{FV} represents the second direction vector of the virtual lens, P_{V} represents a velocity standardized vector of the virtual object in a current frame, clamp (A, B, C) represents the responsive layout function, which is used to limit the value of A to not less than B and not greater than C, and means in an embodiment of the present disclosure that the value of C_{RV}dotP_{V} is not less than −1 and not greater than 1, and dot represents a dot product, i.e., a product of two vectors.

In an optional embodiment of the present disclosure, after obtaining the target adjustment distance, the terminal device can calculate an end point position of the virtual mechanical arm based on the following formula (15):

$${P}_{D} = {P}_{L} + D \qquad ( 15 )$$

In the formula (15), P_{D} represents a coordinate of the end point position of the virtual mechanical arm close to the virtual object, P_{L} represents a coordinate of a current position of the virtual object, and D represents the target adjustment distance.

In an embodiment of the present disclosure, the target adjustment distance of the virtual mechanical arm is first determined based on the first direction vector, the second direction vector, the velocity standardized vector of the object movement velocity, and the preset limit distance. Finally, the end point position of the virtual mechanical arm can be calculated based on the target adjustment distance in a simple and fast way, which can be adapted to any scenario in which real-time calculation is required, thereby greatly improving the efficiency of the virtual lens control.

In an embodiment of the present disclosure, a range trigger control point for detecting current position movement in a preset trigger range may be further configured. The terminal device detects position information of the range trigger control point in real time, and calculates a distance between the range trigger control point and a center point of the preset trigger range, to determine whether a current movement amplitude of the virtual object is out of the preset trigger range. If the current movement amplitude of the virtual object is out of the preset trigger range, the target adjustment distance of the virtual mechanical arm is re-determined based on the above steps 1001-1004, and the end point position of the virtual mechanical arm is adjusted based on the target adjustment distance; while if the current movement amplitude of the virtual object is not out of the preset trigger range, it is not necessary to adjust the end point position of the virtual mechanical arm.

Referring to FIG. 11, in the present disclosure, in the above second embodiment, if the relative movement direction of the virtual object with respect to the virtual lens is away from the virtual lens, the terminal device determines the control point position information of the virtual mechanical arm based on the object position information, the object movement velocity, the lens position information, and the preset limit distance, including the following steps 1101-1002:

Step 1101: determining, by the terminal device and in response to the relative movement direction of the virtual object with respect to the virtual lens being away from the virtual lens, whether a current position of the virtual object is out of a preset trigger range based on the object position information.

Step 1102: determining, by the terminal device and in response to the current position of the virtual object being out of the preset trigger range, the control point position information of the virtual mechanical arm based on the object position information, the object movement velocity, the lens position information, and the preset limit distance.

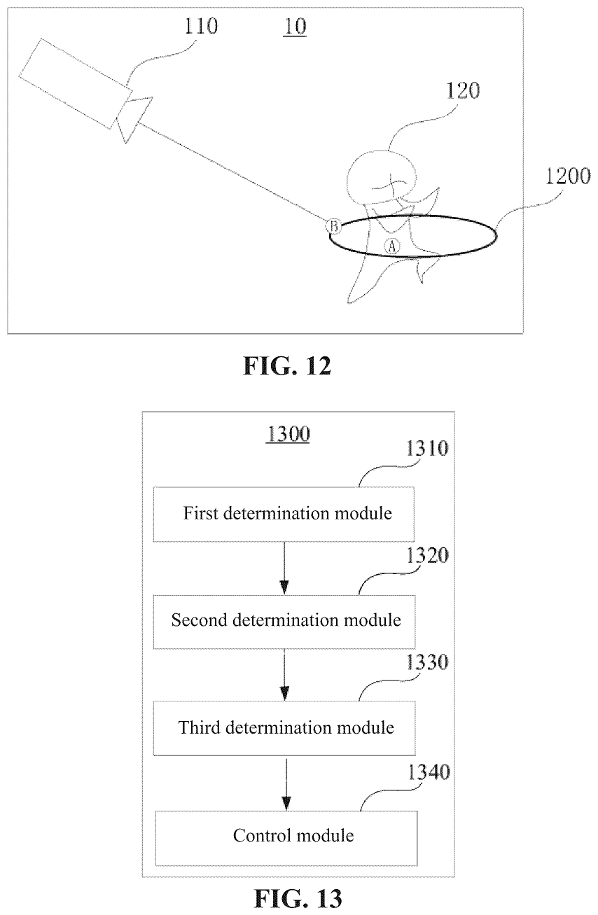

Referring to FIG. 12, the preset trigger range 1200 refers to a threshold that triggers adjustment of the length of the mechanical arm of the virtual lens 110. Only when the virtual object 120 touches the edge of the preset trigger range 1200 or moves out of the preset trigger range, does the terminal device start adjustment of the virtual lens 110, that is, the control point position information of the mechanical arm of the virtual lens 110 is determined based on the object position information, the object movement velocity, the lens position information, and the preset limit distance. Further, the virtual object 120 is within the preset trigger range 1200, and the virtual lens 110 is constant without any adjustment. In this way, the frequent adjustment of the position of the virtual lens 110, which greatly increases the calculation amount of the terminal device, can be avoided, thereby saving calculation resources.

Referring to FIG. 13, in order to implement the above method for controlling a virtual lens, an embodiment of the present disclosure provides an apparatus 1300 for controlling a virtual lens. FIG. 13 shows a schematic architecture diagram of the apparatus 1300 for controlling a virtual lens, including: a first determination module 1310, a second determination module 1320, a third determination module 1330, and a control module 1340, wherein:
the first determination module 1310 is configured to determine an object movement velocity and object position information of a current virtual object;
the second determination module 1320 is configured to determine a relative distance between the virtual lens and the virtual object based on the object movement velocity, wherein the object movement velocity is positively correlated with the relative distance;
the third determination module 1330 is configured to determine a target position of the virtual lens based on the relative distance and the object position information; and
the control module 1340 is configured to control the virtual lens to move to the target position.

The apparatus for controlling a virtual lens provided in embodiments of the present disclosure first determines an object movement velocity and object position information of a current virtual object, determines a relative distance between the virtual lens and the virtual object based on the object movement velocity, then determines a target position of the virtual lens based on the relative distance and the object position information, and finally adjusts the virtual lens to the target position to complete control of the virtual lens. In a first aspect of the present disclosure, the relative distance between the virtual lens and the virtual object is adjusted in real time based on the object movement velocity of the virtual object, so that the relative distance between the virtual lens and the virtual object can be adjusted in real time based on different movement states of the virtual object such as walking, jumping, running, or flying, to construct a picture composition corresponding to a current movement state, and greatly enhance sense of velocity of a game picture, thereby solving the technical problem that the methods for controlling a virtual lens are relatively monotonous at present, and achieving the technical effects of improving diversity and richness of the method for controlling a virtual lens.

In a second aspect, the relative distance between the virtual lens and the virtual object is positively correlated with the virtual lens movement velocity. The farther the virtual mechanical arm is from the virtual object, the larger the movement velocity of the virtual mechanical arm is, and the closer the virtual mechanical arm is to the virtual object, the smaller the movement velocity of the virtual mechanical arm is, thereby making the virtual lens start and stop movement more smoothly, greatly reducing sense of freezing, and greatly improving smoothness of movement of the virtual lens and picture stability.

In an optional embodiment of the present disclosure, the second determination module 1320 is specifically configured to determine a mechanical arm movement velocity of the virtual mechanical arm of the virtual lens; and determine a relative distance between the virtual lens and the virtual object based on relative magnitudes of the object movement velocity and the mechanical arm movement velocity.

As explained in the above steps, the object movement velocity is positively correlated with the movement velocity of the virtual mechanical arm. The terminal device can determine a magnitude of the object movement velocity based on a preset movement velocity. In this embodiment, the terminal device determines the relative magnitude of the object movement velocity based on the mechanical arm movement velocity, and the resulting relative distance between the virtual lens and the virtual object is more consistent with a state of the virtual object in an actual game scenario, achieving higher reliability.

In an optional embodiment of the present disclosure, the second determination module 1320 is specifically configured to increase, in response to the object movement velocity being greater than the mechanical arm movement velocity, a distance between the virtual lens and the virtual object to obtain the relative distance.

In an optional embodiment of the present disclosure, the second determination module 1320 is specifically configured to shorten, in response to the object movement velocity being smaller than the mechanical arm movement velocity, a distance between the virtual lens and the virtual object to obtain the relative distance.

In the embodiment of the present disclosure, the relative magnitudes of the object movement velocity and the mechanical arm movement velocity can be first determined, and if the object movement velocity is greater than the mechanical arm movement velocity, it means that the virtual object moves faster currently, and the distance between the virtual lens and the virtual object is increased correspondingly; on the contrary, if the object movement velocity is smaller than the mechanical arm movement velocity, it means that the virtual object moves slower currently, and the distance between the virtual lens and the virtual object is shortened correspondingly. The movement velocity of the virtual object is determined by the relative magnitude to the mechanical arm movement velocity, so that the relative distance of the virtual lens obtained is more consistent with the state of the virtual object in the actual game scenario, achieving higher reliability.

In an optional embodiment of the present disclosure, a nondimensionalized value of the object movement velocity is equal to a nondimensionalized value of the relative distance.

As shown in Formula (9) above, by adjusting the numerical values of the object movement velocity and the relative distance to equal values, the object movement velocity of the virtual object and the mechanical arm movement velocity of the virtual lens can be kept equal, which means that the relative distance between the virtual object and the virtual lens reaches the maximum value, and more information can be collected on the premise of maintaining the picture composition, so that players can judge the current environment of the virtual object and further improve their game experience.

In an optional embodiment of the present disclosure, the third determination module 1330 is specifically configured to determine current lens position information of the virtual lens; determine a relative movement direction of the virtual object with respect to the virtual lens based on the lens position information and the object movement velocity; and determine the target position of the virtual lens based on the relative movement direction, the relative distance, and the object position information.

In an embodiment of the present disclosure, the relative movement direction of the virtual object with respect to the virtual lens is first determined based on the lens position information and the object movement velocity, and then the target position of the virtual lens is determined based on the relative movement direction, the relative distance, and the object position information, thereby taking into account different lens requirements of the virtual object in different movement directions to the maximum extent, determining the corresponding target position of the virtual lens based on an actual movement direction, and further improving the flexibility, comprehensiveness, and reliability of the method for controlling a virtual lens in the embodiments of the present disclosure.

In an optional embodiment of the present disclosure, the third determination module 1330 is specifically configured to determine, in response to the relative movement direction of the virtual object with respect to the virtual lens being toward the virtual lens, a position having the relative distance from a position where the virtual object is located as the target position of the virtual lens.

In an optional embodiment of the present disclosure, the third determination module 1330 is specifically configured to determine, in response to the relative movement direction of the virtual object with respect to the virtual lens being away from the virtual lens, control point position information of a mechanical arm control point of the virtual mechanical arm based on the object position information, the object movement velocity, the lens position information, and a preset limit distance, wherein the mechanical arm control point refers to an end point of the virtual mechanical arm away from the virtual lens; and determine the target position of the virtual lens based on the control point position information, the relative distance, and the object position information.

The relative movement direction of the virtual object with respect to the virtual lens is away from the virtual lens, that is, the virtual object moves leftward, rightward, or backward with respect to the virtual lens. When the virtual object moves leftward, rightward, or backward with respect to the virtual lens, the virtual lens retains behind the virtual object, and collects fewer scenario elements. Therefore, in this embodiment, the terminal device determines the control point position information of the virtual mechanical arm based on the object position information, the object movement velocity, the lens position information, and the preset limit distance, and then determines the target position of the virtual lens based on mechanical arm control point information, thereby ensuring that the virtual lens collects more information to the maximum extent, enhancing the sense of velocity of the virtual object during movement, and further improving the game experience of the player.

In an optional embodiment of the present disclosure, the third determination module 1330 is specifically configured to determine a first direction vector and a second direction vector of the virtual lens based on the lens position information, wherein planes where the first direction vector and the second direction vector are located are parallel to a plane where the virtual lens is located, and the first direction vector is perpendicular to the second direction vector; determine a target adjustment distance of the virtual mechanical arm based on the first direction vector, the second direction vector, a velocity standardized vector of the object movement velocity, and the preset limit distance; and determine the control point position of the virtual mechanical arm based on the target adjustment distance and the object position information.

In an embodiment of the present disclosure, when the relative movement direction of the virtual object with respect to the virtual lens is away from the virtual lens, the terminal device determines the target adjustment distance of the virtual mechanical arm based on the first direction vector and the second direction vector of the virtual lens, the velocity standardized vector of the object movement velocity, and the preset limit distance, and determines the control point position of the virtual mechanical arm based on the target adjustment distance, so that the mechanical arm control point position of the virtual mechanical arm can automatically adjust the distance based on the actual movement state of the virtual object to obtain a target position that is most suitable for the current state, thereby greatly improving the flexibility and reliability of the virtual lens control.

In an optional embodiment of the present disclosure, the third determination module 1330 is specifically configured to calculate a first inner product of the velocity standardized vector of the object movement velocity and the first direction vector; calculate a product of the first inner product and the preset limit distance; calculate a second inner product of the velocity standardized vector of the object movement velocity and the second direction vector; and calculate a sum of the product and the second inner product to obtain the target adjustment distance of the virtual mechanical arm.

In an embodiment of the present disclosure, the target adjustment distance of the virtual mechanical arm is first determined based on the first direction vector, the second direction vector, the velocity standardized vector of the object movement velocity, and the preset limit distance. Finally, the end point position of the virtual mechanical arm can be calculated based on the target adjustment distance in a simple and fast way, which can be adapted to any scenario in which real-time calculation is required, thereby greatly improving the efficiency of the virtual lens control.

In an optional embodiment of the present disclosure, the third determination module 1330 is specifically configured to determine, in response to the relative movement direction of the virtual object with respect to the virtual lens being away from the virtual lens, whether a current position of the virtual object is out of a preset trigger range based on the object position information; and determine, in response to the current position of the virtual object being out of the preset trigger range, the control point position information of the virtual mechanical arm based on the object position information, the object movement velocity, the lens position information, and the preset limit distance.

Referring to FIG. 12, the preset trigger range 1200 refers to a threshold that triggers adjustment of the length of the mechanical arm of the virtual lens 110. Only when the virtual object 120 touches the edge of the preset trigger range 1200 or moves out of the preset trigger range, is the adjustment of the virtual lens 110 started, that is, the control point position information of the mechanical arm of the virtual lens 110 is determined based on the object position information, the object movement velocity, the lens position information, and the preset limit distance. Further, the virtual object 120 is within the preset trigger range 1200, and the virtual lens 110 is constant without any adjustment. In this way, the frequent adjustment of the position of the virtual lens 110, which greatly increases the calculation amount of the terminal device, can be avoided, thereby saving calculation resources.

An example embodiment of the present disclosure further provides a computer-readable storage medium, which may be implemented as a program product form, and includes a program code. When the program product is run on an electronic device, the program code is used to cause the electronic device to execute the steps according to various example embodiments of the present disclosure described in the above section “Example Methods” of this specification. In an embodiment, the program product may be implemented as a portable compact disk read-only memory (CD-ROM), includes a program code, and may be run on an electronic device, such as a personal computer. However, the program product of the present disclosure is not limited thereto. Herein, a readable storage medium may be any tangible medium containing or storing programs which may be used by, or used in combination with, a command execution system, apparatus, or element.

Any combination of one or more readable mediums may be used as the program product. The readable medium may be a readable signal medium or a readable storage medium. An example of the readable storage medium may include, but is not limited to: electric, magnetic, optical, electromagnetic, infrared, or semiconductor systems, apparatuses, elements, or a combination of any of the above. A more specific example (non-enumerated list) of the readable storage medium includes: electrical connection with one or more wire, a portable disk, a hard disk, a random access memory (RAM), a read only memory (ROM), an erasable programmable read only memory (EPROM or flash memory), an optical fiber, a portable compact disk read only memory (CD-ROM), an optical memory, a magnetic memory, or any suitable combination of the above.

A computer-readable signal medium may include a data signal in a base band or propagating as a part of a carrier wave, in which readable program codes are carried. The propagating data signal may take various forms, including but not limited to an electromagnetic signal, an optical signal, or any suitable combination of the above. The readable signal medium may also be any readable medium except for the readable storage medium. The readable medium is capable of transmitting, propagating or transferring programs for use by, or use in combination with, a command execution system, apparatus, or element.

The program code comprised on the readable medium may be transmitted using any appropriate medium, including but not limited to wireless, wired, optical cable, RF media, etc., or any suitable combination of the foregoing.

The program code for performing operations of the present disclosure may be written in any combination of one or more programming languages, including object-oriented programming languages such as Java and C++, and conventional procedural programming languages such as “C” language or similar programming languages. The program code may be executed entirely on the user's computing device, partly on the user's computing device, as a stand-alone software package, partly on the user's computing device and partly on a remote computing device, or entirely on a remote computing device or server. Where a remote computing device is involved, the remote computing device may be connected to the user's computing device through any type of network, including a local area network (LAN) or a wide area network (WAN), or may be connected to an external computing device (such as, through the Internet using an Internet service provider). In an embodiment of the present disclosure, when the program code stored in the computer-readable storage medium is executed, any step in the method for controlling a virtual lens described above can be implemented.

In an embodiment of the present disclosure, the program code stored in the computer-readable storage medium, when executed, can implement the following steps:
determining an object movement velocity and object position information of a current virtual object; determining a relative distance between the virtual lens and the virtual object based on the object movement velocity, wherein the object movement velocity is positively correlated with the relative distance; determining a target position of the virtual lens based on the relative distance and the object position information; and controlling the virtual lens to move to the target position.

The method provided in embodiments of the present disclosure first determines an object movement velocity and object position information of a current virtual object, determines a relative distance between the virtual lens and the virtual object based on the object movement velocity, then determines a target position of the virtual lens based on the relative distance and the object position information, and finally adjusts the virtual lens to the target position to complete control of the virtual lens. In a first aspect of the embodiments of the present disclosure, the relative distance between the virtual lens and the virtual object is adjusted in real time based on the object movement velocity of the virtual object, so that the relative distance between the virtual lens and the virtual object can be adjusted in real time based on different movement states of the virtual object such as walking, jumping, running, or flying, to construct a picture composition corresponding to a current movement state, and greatly enhance sense of velocity of a game picture, thereby solving the technical problem that the methods for controlling a virtual lens are relatively monotonous at present, and achieving the technical effects of improving the diversity and richness of the method for controlling a virtual lens.

In a second aspect, the relative distance between the virtual lens and the virtual object is positively correlated with the virtual lens movement velocity. The farther the virtual mechanical arm is from the virtual object, the larger the movement velocity of the virtual mechanical arm is, and the closer the virtual mechanical arm is to the virtual object, the smaller the movement velocity of the virtual mechanical arm is, thereby making the virtual lens start and stop movement more smoothly, greatly reducing sense of freezing, and greatly improving smoothness of movement of the virtual lens and picture stability.

In an optional embodiment of the present disclosure, the program code stored in the computer-readable storage medium, when executed, can implement the following steps: determining a mechanical arm movement velocity of a virtual mechanical arm of the virtual lens; and determining the relative distance between the virtual lens and the virtual object based on relative magnitudes of the object movement velocity and the mechanical arm movement velocity.

As explained in the above steps, the object movement velocity is positively correlated with the movement velocity of the virtual mechanical arm. The terminal device can determine a magnitude of the object movement velocity based on a preset movement velocity. In this embodiment, the terminal device determines the relative magnitude of the object movement velocity based on the mechanical arm movement velocity, and the resulting relative distance between the virtual lens and the virtual object is more consistent with a state of the virtual object in an actual game scenario, achieving higher reliability.

In an optional embodiment of the present disclosure, in response to the object movement velocity being greater than the mechanical arm movement velocity, the program code stored in the computer-readable storage medium, when executed, can implement the following steps: increasing the distance between the virtual lens and the virtual object to obtain the relative distance.

In an optional embodiment of the present disclosure, in response to the object movement velocity being smaller than the mechanical arm movement velocity, the program code stored in the computer-readable storage medium, when executed, can implement the following steps: shortening the distance between the virtual lens and the virtual object to obtain the relative distance.

In the embodiment of the present disclosure, the relative magnitudes of the object movement velocity and the mechanical arm movement velocity can be first determined, and if the object movement velocity is greater than the mechanical arm movement velocity, it means that the virtual object moves faster currently, and the distance between the virtual lens and the virtual object is increased correspondingly; on the contrary, if the object movement velocity is smaller than the mechanical arm movement velocity, it means that the virtual object moves slower currently, and the distance between the virtual lens and the virtual object is shortened correspondingly. The movement velocity of the virtual object is determined by the relative magnitude to the mechanical arm movement velocity, so that the relative distance of the virtual lens obtained is more consistent with the state of the virtual object in the actual game scenario, achieving higher reliability.

In an optional embodiment of the present disclosure, a nondimensionalized value of the object movement velocity is equal to a nondimensionalized value of the relative distance.

As shown in Formula (9) above, in the embodiment of the present disclosure, by adjusting the numerical values of the object movement velocity and the relative distance to be equal, the object movement velocity of the virtual object and the mechanical arm movement velocity of the virtual lens can be kept equal, which means that the relative distance between the virtual object and the virtual lens reaches the maximum, and more information can be collected on the premise of maintaining the picture composition, so that players can determine the current environment of the virtual object, which further improve their game experience.

In an optional embodiment of the present disclosure, the program code stored in the computer-readable storage medium, when executed, can implement the following steps: determining current lens position information of the virtual lens; determining a relative movement direction of the virtual object with respect to the virtual lens based on the lens position information and the object movement velocity; and determining the target position of the virtual lens based on the relative movement direction, the relative distance, and the object position information.

In an embodiment of the present disclosure, the relative movement direction of the virtual object with respect to the virtual lens is first determined based on the lens position information and the object movement velocity, and then the target position of the virtual lens is determined based on the relative movement direction, the relative distance, and the object position information, thereby taking into account different lens requirements of the virtual object in different movement directions to the maximum extent, determining the corresponding target position of the virtual lens based on an actual movement direction, and further improving the flexibility, comprehensiveness, and reliability of the method for controlling a virtual lens in the embodiments of the present disclosure.

In an optional embodiment of the present disclosure, in response to the relative movement direction of the virtual object with respect to the virtual lens being toward the virtual lens, the program code stored in the computer-readable storage medium, when executed, can implement the following steps: determining a position having the relative distance from a position where the virtual object is located as the target position of the virtual lens.

In an optional embodiment of the present disclosure, in response to the relative movement direction of the virtual object with respect to the virtual lens being away from the virtual lens, the program code stored in the computer-readable storage medium, when executed, can implement the following steps: determining control point position information of a mechanical arm control point of the virtual mechanical arm based on the object position information, the object movement velocity, the lens position information, and a preset limit distance, wherein the mechanical arm control point refers to an end point of the virtual mechanical arm away from the virtual lens; and determining the target position of the virtual lens based on the control point position information, the relative distance, and the object position information.

The relative movement direction of the virtual object with respect to the virtual lens is away from the virtual lens, that is, the virtual object moves leftward, rightward, or backward with respect to the virtual lens. When the virtual object moves leftward, rightward, or backward with respect to the virtual lens, the virtual lens retains behind the virtual object, and collects fewer scenario elements. Therefore, in this embodiment, the terminal device determines the control point position information of the virtual mechanical arm based on the object position information, the object movement velocity, the lens position information, and the preset limit distance, and then determines the target position of the virtual lens based on mechanical arm control point information, thereby ensuring that the virtual lens collects more information to the maximum extent, enhancing the sense of velocity of the virtual object during movement, and further improving the game experience of the player.

In an optional embodiment of the present disclosure, the program code stored in the computer-readable storage medium, when executed, can implement the following steps: determining a first direction vector and a second direction vector of the virtual lens based on the lens position information, wherein planes where the first direction vector and the second direction vector are located are parallel to a plane where the virtual lens is located, and the first direction vector is perpendicular to the second direction vector; determining a target adjustment distance of the virtual mechanical arm based on the first direction vector, the second direction vector, a velocity standardized vector of the object movement velocity, and the preset limit distance; and determining the control point position of the virtual mechanical arm based on the target adjustment distance and the object position information.

In an embodiment of the present disclosure, when the relative movement direction of the virtual object with respect to the virtual lens is away from the virtual lens, the terminal device determines the target adjustment distance of the virtual mechanical arm based on the first direction vector and the second direction vector of the virtual lens, the velocity standardized vector of the object movement velocity, and the preset limit distance, and determines the control point position of the virtual mechanical arm based on the target adjustment distance, so that the mechanical arm control point position of the virtual mechanical arm can automatically adjust the distance based on the actual movement state of the virtual object to obtain a target position that is most suitable for the current state, thereby greatly improving the flexibility and reliability of the virtual lens control.

In an optional embodiment of the present disclosure, the program code stored in the computer-readable storage medium, when executed, can implement the following steps: calculating a first inner product of the velocity standardized vector of the object movement velocity and the first direction vector; calculating a product of the first inner product and the preset limit distance; calculating a second inner product of the velocity standardized vector of the object movement velocity and the second direction vector; and calculating a sum of the product and the second inner product to obtain the target adjustment distance of the virtual mechanical arm.

In an embodiment of the present disclosure, the target adjustment distance of the virtual mechanical arm is first determined based on the first direction vector, the second direction vector, the velocity standardized vector of the object movement velocity, and the preset limit distance. Finally, the end point position of the virtual mechanical arm can be calculated based on the target adjustment distance in a simple and fast way, which can be adapted to any scenario in which real-time calculation is required, thereby greatly improving the efficiency of the virtual lens control.

In an optional embodiment of the present disclosure, in response to the relative movement direction of the virtual object with respect to the virtual lens being away from the virtual lens, the program code stored in the computer-readable storage medium, when executed, can implement the following steps: determining whether a current position of the virtual object is out of a preset trigger range based on the object position information; and determining, in response to the current position of the virtual object being out of the preset trigger range, the control point position information of the virtual mechanical arm based on the object position information, the object movement velocity, the lens position information, and the preset limit distance.

Referring to FIG. 12, the preset trigger range 1200 refers to a threshold that triggers adjustment of the length of the mechanical arm of the virtual lens 110. Only when the virtual object 120 touches the edge of the preset trigger range 1200 or moves out of the preset trigger range, is the adjustment of the virtual lens 110 started, that is, the control point position information of the mechanical arm of the virtual lens 110 is determined based on the object position information, the object movement velocity, the lens position information, and the preset limit distance. Further, the virtual object 120 is within the preset trigger range 1200, and the virtual lens 110 is constant without any adjustment. In this way, the frequent adjustment of the position of the virtual lens 110, which greatly increases the calculation amount of the terminal device, can be avoided, thereby saving calculation resources.

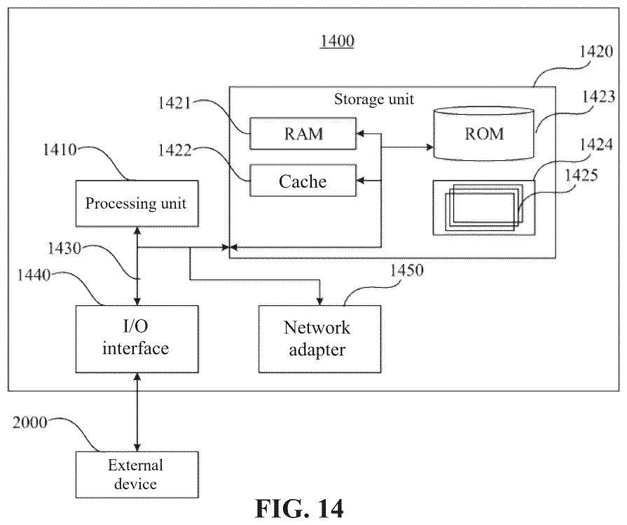

Referring to FIG. 14, an exemplary embodiment of the present disclosure further provides an electronic device 1400, which may be a back-end server of an information platform. The electronic device 1400 is described below with reference to FIG. 14. It should be understood that the electronic device 1400 shown in FIG. 14 is merely an example and should not impose any limitation on the functions and scope of use of the embodiments of the present disclosure.

As shown in FIG. 14, the electronic device 1400 takes the form of a general-purpose computing device. Components of the electronic device 1400 may include, but are not limited to, at least one processing unit 1410, at least one storage unit 1420, and a bus 1430 that connects different system components (including the storage unit 1420 and the processing unit 1410).

The storage unit stores program codes, which can be executed by the processing unit 1410, so that the processing unit 1410 executes the steps described in the above “Exemplary Methods” section of the specification according to various exemplary embodiments of the present disclosure. For example, the processing unit 1410 may execute the method steps shown in FIG. 4.

The storage unit 1420 may include a volatile storage unit, such as a random access storage unit (RAM) 1421 and/or a cache storage unit 1422, and may further include a read-only storage unit (ROM) 1423.

The storage unit 1420 may also include a program/utility 1424 having a set of (at least one) program modules 1425, such program modules 1425 including but not limited to: an operating system, one or more application programs, other program modules, and program data, each of which or some combination thereof may include an implementation of a network environment.

The bus 1430 may include a data bus, an address bus, and a control bus.

The electronic device 1400 may also communicate with one or more external devices 2000 (e.g. a keyboard, a pointing device, a Bluetooth device), and such communication may be performed through an input/output (I/O) interface 1440. The electronic device 1400 may also communicate with one or more networks (e.g. a local area network (LAN), a wide area network (WAN), and/or a public network such as the Internet) via a network adapter 1450. As shown in the figure, the network adapter 1450 communicates with other modules of the electronic device 141400 via the bus 1430. It should be understood that although not shown in the figures, other hardware and/or software modules may be used in conjunction with the electronic device 1400, including but not limited to: microcode, device drivers, redundant processing units, external disk drive arrays, RAID systems, magnetic tape drives, and data backup storage systems.

In an embodiment of the present disclosure, when the program code stored in the electronic device is executed, any step in the method for controlling a virtual lens as described above can be implemented.

In an embodiment of the present disclosure, the program code stored in the electronic device, when executed, can implement the following steps:
determining an object movement velocity and object position information of a current virtual object; determining a relative distance between the virtual lens and the virtual object based on the object movement velocity, wherein the object movement velocity is positively correlated with the relative distance; determining a target position of the virtual lens based on the relative distance and the object position information; and controlling the virtual lens to move to the target position.

The method provided in embodiments of the present disclosure first determines an object movement velocity and object position information of a current virtual object, determines a relative distance between the virtual lens and the virtual object based on the object movement velocity, then determines a target position of the virtual lens based on the relative distance and the object position information, and finally adjusts the virtual lens to the target position to complete control of the virtual lens. In a first aspect of the embodiments of the present disclosure, the relative distance between the virtual lens and the virtual object is adjusted in real time based on the object movement velocity of the virtual object, so that the relative distance between the virtual lens and the virtual object can be adjusted in real time based on different movement states of the virtual object such as walking, jumping, running, or flying, to construct a picture composition corresponding to a current movement state, and greatly enhance sense of velocity of a game picture, thereby solving the technical problem that the methods for controlling a virtual lens are relatively monotonous at present, and achieving the technical effects of improving the diversity and richness of the method for controlling a virtual lens.

In a second aspect, the relative distance between the virtual lens and the virtual object is positively correlated with the virtual lens movement velocity. The farther the virtual mechanical arm is from the virtual object, the larger the movement velocity of the virtual mechanical arm is, and the closer the virtual mechanical arm is to the virtual object, the smaller the movement velocity of the virtual mechanical arm is, thereby making the virtual lens start and stop movement more smoothly, greatly reducing sense of freezing, and greatly improving smoothness of movement of the virtual lens and picture stability.

In an optional embodiment of the present disclosure, the program code stored in the electronic device, when executed, can implement the following steps: determining a mechanical arm movement velocity of a virtual mechanical arm of the virtual lens; and determining the relative distance between the virtual lens and the virtual object based on relative magnitudes of the object movement velocity and the mechanical arm movement velocity.

As explained in the above steps, the object movement velocity is positively correlated with the movement velocity of the virtual mechanical arm. The terminal device can determine a magnitude of the object movement velocity based on a preset movement velocity. In this embodiment, the terminal device determines the relative magnitude of the object movement velocity based on the mechanical arm movement velocity, and the resulting relative distance between the virtual lens and the virtual object is more consistent with a state of the virtual object in an actual game scenario, achieving higher reliability.

In an optional embodiment of the present disclosure, in response to the object movement velocity being greater than the mechanical arm movement velocity, the program code stored in the electronic device, when executed, can implement the following steps: increasing the distance between the virtual lens and the virtual object to obtain the relative distance.

In an optional embodiment of the present disclosure, in response to the object movement velocity being smaller than the mechanical arm movement velocity, the program code stored in the electronic device, when executed, can implement the following steps: shortening the distance between the virtual lens and the virtual object to obtain the relative distance.

In the embodiment of the present disclosure, the relative magnitudes of the object movement velocity and the mechanical arm movement velocity can be first determined, and if the object movement velocity is greater than the mechanical arm movement velocity, it means that the virtual object moves faster currently, and the distance between the virtual lens and the virtual object is increased correspondingly; on the contrary, if the object movement velocity is smaller than the mechanical arm movement velocity, it means that the virtual object moves slower currently, and the distance between the virtual lens and the virtual object is shortened correspondingly. The movement velocity of the virtual object is determined by the relative magnitude to the mechanical arm movement velocity, so that the relative distance of the virtual lens obtained is more consistent with the state of the virtual object in the actual game scenario, achieving higher reliability.

In an optional embodiment of the present disclosure, a nondimensionalized value of the object movement velocity is equal to a nondimensionalized value of the relative distance.

As shown in Formula (9) above, in the embodiment of the present disclosure, by adjusting the numerical values of the object movement velocity and the relative distance to be equal, the object movement velocity of the virtual object and the mechanical arm movement velocity of the virtual lens can be kept equal, which means that the relative distance between the virtual object and the virtual lens reaches the maximum, and more information can be collected on the premise of maintaining the picture composition, so that players can determine the current environment of the virtual object, which further improve their game experience.

In an optional embodiment of the present disclosure, the program code stored in the electronic device, when executed, can implement the following steps: determining current lens position information of the virtual lens; determining a relative movement direction of the virtual object with respect to the virtual lens based on the lens position information and the object movement velocity; and determining the target position of the virtual lens based on the relative movement direction, the relative distance, and the object position information.

In an embodiment of the present disclosure, the relative movement direction of the virtual object with respect to the virtual lens is first determined based on the lens position information and the object movement velocity, and then the target position of the virtual lens is determined based on the relative movement direction, the relative distance, and the object position information, thereby taking into account different lens requirements of the virtual object in different movement directions to the maximum extent, determining the corresponding target position of the virtual lens based on an actual movement direction, and further improving the flexibility, comprehensiveness, and reliability of the method for controlling a virtual lens in the embodiments of the present disclosure.

In an optional embodiment of the present disclosure, in response to the relative movement direction of the virtual object with respect to the virtual lens being toward the virtual lens, the program code stored in the electronic device, when executed, can implement the following steps: determining a position having the relative distance from a position where the virtual object is located as the target position of the virtual lens.

In an optional embodiment of the present disclosure, in response to the relative movement direction of the virtual object with respect to the virtual lens being away from the virtual lens, the program code stored in the electronic device, when executed, can implement the following steps: determining control point position information of a mechanical arm control point of the virtual mechanical arm based on the object position information, the object movement velocity, the lens position information, and a preset limit distance, wherein the mechanical arm control point refers to an end point of the virtual mechanical arm away from the virtual lens; and determining the target position of the virtual lens based on the control point position information, the relative distance, and the object position information.

The relative movement direction of the virtual object with respect to the virtual lens is away from the virtual lens, that is, the virtual object moves leftward, rightward, or backward with respect to the virtual lens. When the virtual object moves leftward, rightward, or backward with respect to the virtual lens, the virtual lens retains behind the virtual object, and collects fewer scenario elements. Therefore, in this embodiment, the terminal device determines the control point position information of the virtual mechanical arm based on the object position information, the object movement velocity, the lens position information, and the preset limit distance, and then determines the target position of the virtual lens based on mechanical arm control point information, thereby ensuring that the virtual lens collects more information to the maximum extent, enhancing the sense of velocity of the virtual object during movement, and further improving the game experience of the player.

In an optional embodiment of the present disclosure, the program code stored in the electronic device, when executed, can implement the following steps: determining a first direction vector and a second direction vector of the virtual lens based on the lens position information, wherein planes where the first direction vector and the second direction vector are located are parallel to a plane where the virtual lens is located, and the first direction vector is perpendicular to the second direction vector; determining a target adjustment distance of the virtual mechanical arm based on the first direction vector, the second direction vector, a velocity standardized vector of the object movement velocity, and the preset limit distance; and determining the control point position of the virtual mechanical arm based on the target adjustment distance and the object position information.

In an embodiment of the present disclosure, when the relative movement direction of the virtual object with respect to the virtual lens is away from the virtual lens, the terminal device determines the target adjustment distance of the virtual mechanical arm based on the first direction vector and the second direction vector of the virtual lens, the velocity standardized vector of the object movement velocity, and the preset limit distance, and determines the control point position of the virtual mechanical arm based on the target adjustment distance, so that the mechanical arm control point position of the virtual mechanical arm can automatically adjust the distance based on the actual movement state of the virtual object to obtain a target position that is most suitable for the current state, thereby greatly improving the flexibility and reliability of the virtual lens control.

In an optional embodiment of the present disclosure, the program code stored in the electronic device, when executed, can implement the following steps: calculating a first inner product of the velocity standardized vector of the object movement velocity and the first direction vector; calculating a product of the first inner product and the preset limit distance; calculating a second inner product of the velocity standardized vector of the object movement velocity and the second direction vector; and calculating a sum of the product and the second inner product to obtain the target adjustment distance of the virtual mechanical arm.

In an embodiment of the present disclosure, the target adjustment distance of the virtual mechanical arm is first determined based on the first direction vector, the second direction vector, the velocity standardized vector of the object movement velocity, and the preset limit distance. Finally, the end point position of the virtual mechanical arm can be calculated based on the target adjustment distance in a simple and fast way, which can be adapted to any scenario in which real-time calculation is required, thereby greatly improving the efficiency of the virtual lens control.

In an optional embodiment of the present disclosure, in response to the relative movement direction of the virtual object with respect to the virtual lens being away from the virtual lens, the program code stored in the electronic device, when executed, can implement the following steps: determining whether a current position of the virtual object is out of a preset trigger range based on the object position information; and determining, in response to the current position of the virtual object being out of the preset trigger range, the control point position information of the virtual mechanical arm based on the object position information, the object movement velocity, the lens position information, and the preset limit distance.

Referring to FIG. 12, the preset trigger range 1200 refers to a threshold that triggers adjustment of the length of the mechanical arm of the virtual lens 110. Only when the virtual object 120 touches the edge of the preset trigger range 1200 or moves out of the preset trigger range, is the adjustment of the virtual lens 110 started, that is, the control point position information of the mechanical arm of the virtual lens 110 is determined based on the object position information, the object movement velocity, the lens position information, and the preset limit distance. Further, the virtual object 120 is within the preset trigger range 1200, and the virtual lens 110 is constant without any adjustment. In this way, the frequent adjustment of the position of the virtual lens 110, which greatly increases the calculation amount of the terminal device, can be avoided, thereby saving calculation resources.

The method for controlling a virtual lens provided in the present disclosure first determines an object movement velocity and object position information of a virtual object, determines a relative distance between the virtual lens and the virtual object based on the object movement velocity, then determines a target position of the virtual lens based on the relative distance and the object position information, and finally adjusts the virtual lens to the target position to complete control of the virtual lens. According to a first aspect of the present disclosure, the relative distance between the virtual lens and the virtual object is adjusted in real time based on the object movement velocity of the virtual object. This allows adjusting the relative distance between the virtual lens and the virtual object in real time based on different movement states of the virtual object such as walking, jumping, running, or flying, to construct a picture composition corresponding to a current movement state. The disclosed method may greatly enhance sense of velocity of a game picture, thereby solving the technical problem that the methods for controlling a virtual lens being relatively monotonous at present. This approach may also achieves the technical effects of improving diversity and richness of the method for controlling a virtual lens.

According to a second aspect of the present disclosure, the relative distance between the virtual lens and the virtual object is positively correlated with the virtual lens movement velocity. The farther the virtual mechanical arm is from the virtual object, the larger the movement velocity of the virtual mechanical arm is, and the closer the virtual mechanical arm is to the virtual object, the smaller the movement velocity of the virtual mechanical arm is. This approach makes the virtual lens start and stop movement more smoothly, greatly reducing sense of freezing, and greatly improving smoothness of movement of the virtual lens.

It should be noted that, although several modules or units of the device for action execution are mentioned in the above detailed description, such division is not mandatory. Actually, according to exemplary embodiments of the present disclosure, the features and functions of two or more modules or units described above may be embodied in one module or unit. On the contrary, the features and functions of one module or unit described above may be further divided and embodied by multiple modules or units.

Those skilled in the art will appreciate that various aspects of the present disclosure may be implemented as a system, method or program product. Therefore, various aspects of the present disclosure may be specifically implemented in the following forms, namely: a complete hardware implementation, a complete software implementation (including firmware, microcode, etc.), or an implementation that combines hardware and software aspects, which may be collectively referred to herein as a “circuit,” “module,” or “system.” Other embodiments of the present disclosure will be apparent to those skilled in the art from consideration of the specification and practice of the invention disclosed herein. The present disclosure is intended to cover any modifications, uses or adaptations of the present disclosure, which follow the general principles of the present disclosure and include common knowledge or customary technical means in the art not disclosed in the present disclosure. It is intended that the specification and embodiments be considered as exemplary only, with the true scope and spirit of the present disclosure being indicated by the claims.

It should be understood that the present disclosure is not limited to the exact construction that has been described above and shown in the drawings, and that various modifications and changes may be made without departing from the scope thereof. The scope of the present disclosure is limited only by the appended claims.

1. A method for controlling a virtual lens, comprising:
determining an object movement velocity and object position information of a virtual object;
determining a relative distance between the virtual lens and the virtual object based on the object movement velocity, wherein the object movement velocity is positively correlated with the relative distance;
determining a target position of the virtual lens based on the relative distance and the object position information; and
controlling the virtual lens to move to the target position.

2. The method of claim 1, wherein the determining the relative distance between the virtual lens and the virtual object based on the object movement velocity comprises:
determining a mechanical arm movement velocity of a virtual mechanical arm of the virtual lens; and
determining the relative distance between the virtual lens and the virtual object based on relative magnitudes of the object movement velocity and the mechanical arm movement velocity.

3. The method of claim 2, wherein the determining the relative distance between the virtual lens and the virtual object based on the relative magnitudes of the object movement velocity and the mechanical arm movement velocity comprises:
increasing, in response to the object movement velocity being greater than the mechanical arm movement velocity, a distance between the virtual lens and the virtual object to obtain the relative distance.

4. The method of claim 2, wherein determining the relative distance between the virtual lens and the virtual object based on the relative magnitudes of the object movement velocity and the mechanical arm movement velocity comprises:
shortening, in response to the object movement velocity being smaller than the mechanical arm movement velocity, a distance between the virtual lens and the virtual object to obtain the relative distance.

5. The method of claim 1, wherein a nondimensionalized value of the object movement velocity is equal to a nondimensionalized value of the relative distance.

6. The method of claim 1, wherein the determining the target position of the virtual lens based on the relative distance and the object position information comprises:
determining lens position information of the virtual lens;
determining a relative movement direction of the virtual object with respect to the virtual lens based on the lens position information and the object movement velocity; and
determining the target position of the virtual lens based on the relative movement direction, the relative distance, and the object position information.

7. The method of claim 6, wherein the determining the target position of the virtual lens based on the relative movement direction, the relative distance, and the object position information comprises:
determining, in response to the relative movement direction of the virtual object with respect to the virtual lens being toward the virtual lens, a position having the relative distance from a position where the virtual object is located as the target position of the virtual lens.

8. The method of claim 6, wherein the determining the target position of the virtual lens based on the relative movement direction, the relative distance, and the object position information comprises:
determining, in response to the relative movement direction of the virtual object with respect to the virtual lens being away from the virtual lens, control point position information of a mechanical arm control point of a virtual mechanical arm based on the object position information, the object movement velocity, the lens position information, and a preset limit distance, wherein the mechanical arm control point refers to an end point of the virtual mechanical arm away from the virtual lens; and
determining the target position of the virtual lens based on the control point position information, the relative distance, and the object position information.

9. The method of claim 8, wherein determining the control point position information of the mechanical arm control point of the virtual mechanical arm based on the object position information, the object movement velocity, the lens position information, and the preset limit distance comprises:
determining a first direction vector and a second direction vector of the virtual lens based on the lens position information, wherein planes where the first direction vector and the second direction vector are located are parallel to a plane where the virtual lens is located, and the first direction vector is perpendicular to the second direction vector;
determining a target adjustment distance of the virtual mechanical arm based on the first direction vector, the second direction vector, a velocity standardized vector of the object movement velocity, and the preset limit distance; and
determining the control point position of the virtual mechanical arm based on the target adjustment distance and the object position information.

10. The method of claim 9, wherein determining the target adjustment distance of the virtual mechanical arm based on the first direction vector, the second direction vector, the velocity standardized vector of the object movement velocity, and the preset limit distance comprises:
calculating a first inner product of the velocity standardized vector of the object movement velocity and the first direction vector;
calculating a product of the first inner product and the preset limit distance;
calculating a second inner product of the velocity standardized vector of the object movement velocity and the second direction vector; and
calculating a sum of the product and the second inner product to obtain the target adjustment distance of the virtual mechanical arm.

11. The method of claim 8, wherein determining, in response to the relative movement direction of the virtual object with respect to the virtual lens being away from the virtual lens, the control point position information of the virtual mechanical arm based on the object position information, the object movement velocity, the lens position information, and the preset limit distance comprises:
determining, in response to the relative movement direction of the virtual object with respect to the virtual lens being away from the virtual lens, whether a position of the virtual object is out of a preset trigger range based on the object position information; and
determining, in response to the position of the virtual object being out of the preset trigger range, the control point position information of the virtual mechanical arm based on the object position information, the object movement velocity, the lens position information, and the preset limit distance.

12. (canceled)

13. One or more non-transitory computer-readable storage media containing, in any combination, computer program code that, when executed by a computer system, performs an operation comprising:
determining an object movement velocity and object position information of a virtual object;
determining a relative distance between a virtual lens and the virtual object based on the object movement velocity, wherein the object movement velocity is positively correlated with the relative distance;
determining a target position of the virtual lens based on the relative distance and the object position information; and
controlling the virtual lens to move to the target position.

14. A system, comprising:
one or more memories collectively containing one or more programs; and
one or more processors, wherein the one or more processors are configured to, individually or collectively, perform an operation comprising:
determining an object movement velocity and object position information of a current virtual object;
determining a relative distance between a virtual lens and the virtual object based on the object movement velocity, wherein the object movement velocity is positively correlated with the relative distance;
determining a target position of the virtual lens based on the relative distance and the object position information; and
controlling the virtual lens to move to the target position.

15. The system of claim 14, wherein determining the relative distance between the virtual lens and the virtual object based on the object movement velocity comprises:
determining a mechanical arm movement velocity of a virtual mechanical arm of the virtual lens; and
determining the relative distance between the virtual lens and the virtual object based on relative magnitudes of the object movement velocity and the mechanical arm movement velocity.

16. The system of claim 15, wherein determining the relative distance between the virtual lens and the virtual object based on the relative magnitudes of the object movement velocity and the mechanical arm movement velocity comprises:
increasing, in response to the object movement velocity being greater than the mechanical arm movement velocity, a distance between the virtual lens and the virtual object to obtain the relative distance; or
shortening, in response to the object movement velocity being smaller than the mechanical arm movement velocity, a distance between the virtual lens and the virtual object to obtain the relative distance.

17. The system of claim 14, wherein a nondimensionalized value of the object movement velocity is equal to a nondimensionalized value of the relative distance.

18. The system of claim 14, wherein determining the target position of the virtual lens based on the relative distance and the object position information comprises:
determining lens position information of the virtual lens;
determining a relative movement direction of the virtual object with respect to the virtual lens based on the lens position information and the object movement velocity; and
determining the target position of the virtual lens based on the relative movement direction, the relative distance, and the object position information.

19. The system of 18, wherein determining the target position of the virtual lens based on the relative movement direction, the relative distance, and the object position information comprises:
determining, in response to the relative movement direction of the virtual object with respect to the virtual lens being toward the virtual lens, a position having the relative distance from a position where the virtual object is located as the target position of the virtual lens.

20. The system of 18, wherein determining the target position of the virtual lens based on the relative movement direction, the relative distance, and the object position information comprises:
determining, in response to the relative movement direction of the virtual object with respect to the virtual lens being away from the virtual lens, control point position information of a mechanical arm control point of a virtual mechanical arm based on the object position information, the object movement velocity, the lens position information, and a preset limit distance, wherein the mechanical arm control point refers to an end point of the virtual mechanical arm away from the virtual lens; and
determining the target position of the virtual lens based on the control point position information, the relative distance, and the object position information.

21. The system of 20, wherein determining the control point position information of the mechanical arm control point of the virtual mechanical arm based on the object position information, the object movement velocity, the lens position information, and the preset limit distance comprises:
determining a first direction vector and a second direction vector of the virtual lens based on the lens position information, wherein planes where the first direction vector and the second direction vector are located are parallel to a plane where the virtual lens is located, and the first direction vector is perpendicular to the second direction vector;
determining a target adjustment distance of the virtual mechanical arm based on the first direction vector, the second direction vector, a velocity standardized vector of the object movement velocity, and the preset limit distance; and
determining the control point position of the virtual mechanical arm based on the target adjustment distance and the object position information.
